(19) United States
(12) Patent Application Publication
(10) Pub. No.: US 2013/0059954 A1
(43) Pub. Date: Mar. 7, 2013

(54) GLUE STICKS FORMULATED WITH ACRYLIC DISPERSIONS

(71) Applicants: Joginder Kukreja, Brooklin (CA); Van R. Foster, Westerville, OH (US); Dana L. Conover, Dublin, OH (US)

(72) Inventors: Joginder Kukreja, Brooklin (CA); Van R. Foster, Westerville, OH (US); Dana L. Conover, Dublin, OH (US)

(73) Assignee: ELMER'S PRODUCTS, INC., Westerville, OH (US)

(21) Appl. No.: 13/603,588

(22) Filed: Sep. 5, 2012

Related U.S. Application Data
(60) Provisional application No. 61/531,339, filed on Sep. 6, 2011.

(51) Int. Cl. C09J 133/00; C08K 5/17; C08K 5/5435; C08K 3/22; C08K 5/053; C08K 5/098; C08K 3/20

(52) U.S. Cl. 524/114; 524/560; 524/394; 524/247; 524/388

(57) ABSTRACT

A glue stick formulation that includes at least one acrylic dispersion; at least one solvent; at least one defoamer; at least one fatty acid; at least one caustic solution; at least one processing oil; and at least one adhesion promoter. At least one color indicator and at least one organic amine may also be included in some versions of this formulation.

### CROSS-REFERENCE TO RELATED APPLICATIONS

This patent application claims the benefit of U.S. Provisional Patent Application Ser. No. 61/531,339 filed on Sep. 6, 2011 and entitled “Glue Sticks Formulated with Acrylic Dispersions,” the disclosure of which is hereby incorporated by reference herein in its entirety and made part of the present U.S. utility patent application for all purposes.

### BACKGROUND OF THE INVENTION

The present invention relates generally to adhesives and more specifically to solid or semi-solid glue sticks that include acrylic dispersions. Glue stick products are commonly used in the stationery field by both adults and children for gluing paper and other craft materials together or to other surfaces. With regard to such products, properties such as non-toxicity, ease of application from a suitable dispenser, and water clean-up are typically important; therefore, glue sticks that are commercially available usually possess some or all of these key properties.

Commercially available glue stick formulas and products typically utilize either polyvinylpyrrolidone (PVP) or a modified-polyvinyl acetate (PVA) polymer. PVP-based adhesive formulas are known to provide better overall performance than modified-PVA formulas. Ease of lubricity, package stability and better adhesion compared to modified-PVA formulas are characteristic of PVP-based formulas. Although modified PVA-based adhesives can be formulated to deliver faster adhesion development, such formulas often lack many of the aforementioned desirable properties of PVP-based formulas. However, PVP is typically provided as a high-viscosity fluid at room temperature or as a powder, which involves dissolving the raw material in water at a high temperature. This aspect of PVP lengthens production time and makes the manufacturing process less energy efficient. Therefore, there is an ongoing need for a glue stick formula that provides functional characteristics similar to PVP-based formulas, but that can be more easily manipulated during the manufacturing process.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first glue stick formulation is provided. This formulation includes one or more acrylic dispersions. This formulation may also include at least one solvent; at least one defoamer; at least one fatty acid; at least one caustic solution; at least one processing oil; and at least one adhesion promoter. At least one color indicator and at least one organic amine may also be included.

In accordance with another aspect of the present invention, a second glue stick formulation is provided. This formulation includes one or more acrylic dispersions in addition to at least one solvent; at least one defoamer; at least one fatty acid; at least one caustic solution; at least one processing oil; and at least one adhesion promoter. At least one color indicator and at least one organic amine may also be included.

In yet another aspect of this invention, a third glue stick formulation is provided. This formulation includes one or more acrylic dispersions in addition to at least one solvent, wherein the at least one solvent is water; at least one defoamer; at least one fatty acid, wherein the at least one fatty acid is sodium stearate; at least one caustic solution; at least one processing oil, wherein the at least one processing old is glycerin; and at least one adhesion promoter. At least one color indicator and at least one organic amine may also be included.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the associated descriptions are to be regarded as illustrative and not restrictive in nature.

### DESCRIPTION OF THE INVENTION

Exemplary embodiments of the present invention are now described with reference to the examples provided herein. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention utilizes acrylic dispersion technology as a unique polymer option for formulating glue sticks and the like. This technology provides improved overall adhesion, especially for non-wood or paper substrates, compared to PVP-based adhesives and modified PVA-based adhesives. Additionally, silane coupling agents are utilized to further improve adhesion to non-porous surfaces. Such properties are obtained without sacrificing ease of lubricity or package stability, both of which are important for a properly functioning glue stick product. Because the acrylic dispersions used in the present invention are low viscosity liquids, production time is reduced when compared to traditional PVP-based technology.

PVP-based technology may require a product formulator to stabilize a color indicator (e.g., o-cresolphthalein or thymolphthalein) with a sodium hydroxide solution to maintain a high pH value. The use of sodium hydroxide for acrylic glue stick products does not provide good color-disappearing ability after the glue stick is applied to paper and it dries. The color also degrades over time if a strong caustic solution is used. In one embodiment of the formula of the present invention, an organic amine (e.g., 2-amino-2-methyl-1-propanol, a.k.a., AMP-95) is included as a partial replacement for the caustic solution. This organic amine provides good color stabilization as the product ages, provides good color-disappearing properties after the glue stick is applied to paper, and formulation pH is maintained without degrading the included color indicators. Organic amines are not currently used in the adhesives industry to stabilize PVP or modified-PVA glue stick formulations. This approach is also believed to increase the ease of lubricity of the glue stick as it is applied to a substrate.

Having generally described this invention, a further understanding can be obtained by reference to certain specific examples detailed below, which are provided for purposes of illustration only and are not intended to be all inclusive or limiting unless otherwise specified. A first exemplary formulation provides a general-purpose acrylic glue stick; a second exemplary formulation provides a color-changing/disappearing acrylic school glue stick; and a third exemplary formulation provides an extra-strength glue stick.

### EXAMPLE I

General-Purpose Acrylic Glue Stick Formulation (Formula # 161)

| Ingredient | Description | % (by wt) |
|---|---|---|
| DSM Neorez BT-63 | acrylic dispersion | 51.00 |
| DSM Neorez XK-39 | acrylic dispersion | 9.00 |
| Deionized Water | solvent | 11.20 |
| Antifoam-C (Sigma-Aldrich) | defoamer | 0.50 |
| Sodium Stearate | fatty acid | 3.58 |
| 19.8% Sodium Hydroxide Soln. | caustic solution | 20.84 |
| Propylene Glycol | processing oil | 3.80 |
| Wetlink-78 (Momentive, Inc.) | adhesion promoter | 0.08 |
| | | 100.00 |

The first exemplary formula is prepared by adding the listed acrylic dispersions (DSM Coating Resins, Ceintuurbaan 5, Zwolle, The Netherlands), deionized water and Antifoam-C into a mixer under agitation. After the mixing temperature is raised to 70-75° C., sodium stearate is added and allowed to mix for 30-45 minutes. After mixing into a homogeneous blend, the caustic solution and propylene glycol are added and mixed for 10-15 minutes. The silane adhesion promoter (e.g., Wetlink 78) is added and mixed under vacuum for 5-10 minutes. The molten glue is then filled into an empty glue stick container using a gravity feed method (i.e., flood filling) which is easily performed due to the very low viscosity of the product at high temperatures.

### EXAMPLE II

Color-Changing Acrylic School Glue Stick Formulation (Formula # 304)

| Ingredient | Description | % (by wt) |
|---|---|---|
| DSM Neorez BT-63 | acrylic dispersion | 60.00 |
| Deionized Water | solvent | 20.60 |
| Antifoam-C (Sigma-Aldrich) | defoamer | 0.30 |
| Sodium Stearate | fatty acid | 3.60 |
| 37.4% Sodium Hydroxide Soln. | caustic solution | 10.00 |
| Glycerin | processing oil | 4.29 |
| o-cresolphthalein | color indicator | 0.10 |
| thymolphthalein | color indicator | 0.01 |
| Wetlink-78 (Momentive, Inc.) | adhesion promoter | 0.10 |
| AMP-95 | organic amine | 1.00 |
| | | 100.00 |

The second exemplary formula is prepared by adding the listed acrylic dispersions, deionized water and Antifoam-C into a mixer under agitation. After the mixing temperature is raised to 70-75° C., sodium stearate is added and allowed to mix for 30-45 minutes. After mixing into a homogeneous blend, the caustic solution and glycerin are added and mixed for 10-15 minutes. The o-cresolphthalein and thymolphthalein, after being wetted out with a small amount of glycerin which is withheld from the total formulation, are then added under agitation. After mixing for 5 minutes, the silane adhesion promoter (e.g., Wetlink 78) is added and mixed 5 minutes. The AMP-95 is added to the mixture and allowed to mix 5-10 minutes under vacuum. The molten glue is then filled into an empty glue stick container.

### EXAMPLE III

Extra-Strength Acrylic Glue Stick Formulation (Formula #303)

| Ingredient | Description | % (by wt) |
|---|---|---|
| DSM Neorez BT-63 | acrylic dispersion | 65.50 |
| DSM Neorez XK-39 | acrylic dispersion | 4.50 |
| Deionized Water | solvent | 8.70 |
| Antifoam-C (Sigma-Aldrich) | defoamer | 0.30 |
| Sodium Stearate | fatty acid | 3.60 |
| 37.4% Sodium Hydroxide Soln. | caustic solution | 13.50 |
| Glycerin | processing oil | 3.80 |
| Wetlink-78 (Momentive, Inc.) | adhesion promoter | 0.10 |
| | | 100.00 |

The third exemplary formula is prepared by adding the acrylic dispersions, deionized water and Antifoam-C into a mixer under agitation. After the mixing temperature is raised to 70-75° C., sodium stearate is added and allowed to mix for 30-45 minutes. After mixing into a homogeneous blend, the caustic solution and glycerin are added and mixed for 10-15 minutes. The silane adhesion promoter (e.g., Wetlink 78) is added and mixed under vacuum for 5-10 minutes. If the formula described above does not flow easily, a positive pressure filling device (i.e., a press) may be utilized to fill the product into an appropriate glue stick container.

Essentially, the present invention provides glue stick formulas based on acrylic dispersion technology, which is not typically used to formulate consumer glue stick products, as well as a novel means for stabilizing the color-disappearing acrylic glue stick, and a novel means of filling highly viscous glue sticks. While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A glue stick formulation, comprising at least one acrylic dispersion.

2. The formulation of claim 1, further comprising:
(a) at least one solvent;
(b) at least one defoamer;
(c) at least one fatty acid;
(d) at least one caustic solution;
(e) at least one processing oil; and
(f) at least one adhesion promoter.

3. The formulation of claim 2, further comprising at least one color indicator.

4. The formulation of claim 3, further comprising at least one organic amine.

5. The formulation of claim 2, wherein the at least one solvent is water.

6. The formulation of claim 2, wherein the at least one fatty acid is sodium stearate.

7. The formulation of claim 2, wherein the at least one caustic solution further includes sodium hydroxide.

8. The formulation of claim 2, wherein the at least one processing oil is glycerin.

9. The formulation of claim 2, wherein the adhesion promoter is a silane adhesion promoter.

10. A glue stick formulation, comprising:
(a) at least one acrylic dispersion;
(b) at least one solvent;
(c) at least one defoamer; (d) at least one fatty acid;
(e) at least one caustic solution;
(f) at least one processing oil; and
(g) at least one adhesion promoter.

11. The formulation of claim 10, further comprising at least one color indicator.

12. The formulation of claim 11, further comprising at least one organic amine.

13. The formulation of claim 10, wherein the at least one solvent is water.

14. The formulation of claim 10, wherein the at least one fatty acid is sodium stearate.

15. The formulation of claim 10, wherein the at least one caustic solution further includes sodium hydroxide.

16. The formulation of claim 10, wherein the at least one processing oil is glycerin.

17. The formulation of claim 10, wherein the adhesion promoter is a silane adhesion promoter.

18. A glue stick formulation, comprising:
(a) at least one acrylic dispersion;
(b) at least one solvent, wherein the at least one solvent is water;
(c) at least one defoamer;
(d) at least one fatty acid, wherein the at least one fatty acid is sodium stearate;
(e) at least one caustic solution;
(f) at least one processing oil, wherein the at least one processing old is glycerin; and
(g) at least one adhesion promoter.

19. The formulation of claim 18, further comprising at least one color indicator.

20. The formulation of claim 19, further comprising at least one organic amine.
